(19) United States
(12) Patent Application Publication
(10) Pub. No.: US 2012/0233439 A1
(43) Pub. Date: Sep. 13, 2012

(54) Implementing TLB Synchronization for Systems with Shared Virtual Memory Between Processing Devices

(76) Inventors: Boris Ginzburg, Haifa (IL); Esfir Natanzon, Haifa (IL); Ilya Osadchiy, Haifa (IL); Ronny Ronen, Haifa (IL); Eliezer Weissmann, Haifa (IL); Yoav Zach, Pardes Hana Karkur (IL); Robert L. Farrell, Granite Bay, CA (US)

(21) Appl. No.: 13/045,688

(22) Filed: Mar. 11, 2011

(51) Int. Cl. G06F 12/10

(52) U.S. Cl. 711/206; 711/E12.059

(57) ABSTRACT

Page faults arising in a graphics processing unit may be handled by an operating system running on the central processing unit. In some embodiments, this means that unpinned memory can be used for the graphics processing unit. Using unpinned memory in the graphics processing unit may expand the capabilities of the graphics processing unit in some cases.

### BACKGROUND

This relates generally to synchronization of translation look-aside buffers between central processing units (CPU) and other processing devices, such as graphics processing units.

A translation look-aside buffer (TLB) is a central processing unit cache that a memory management unit (MMU) uses to improve virtual address translation speed. When the MMU should translate a virtual to physical address, it looks first into TLB. If the requested address is present in the TLB, then the retrieved physical address can be used to access memory. This is called a TLB hit. If the requested address is not in the TLB, it is a miss, and the translation proceeds by looking up the page table in a process called a page walk. The page walk is an expensive process, as it involves reading the contents of multiple memory locations and using them to compute the physical address. After the physical address is determined by the page walk, the virtual address to physical address mapping is entered into the TLB.

In conventional systems, separate page tables are used by the central processing unit and the graphics processing unit. The operating system manages the host page table used by the central processing unit and a graphics processing unit driver manages the page table used by the graphics processing unit. The graphics processing unit driver copies data from user space into the driver memory for processing on the graphics processing unit. Complex data structures are repacked into an array when pointers are replaced by offsets.

The overhead related to copying and repacking limits graphics processing unit applications where data is represented as arrays. Thus, graphics processing units may be of limited value in some applications, including those that involve complex data structures such as databases.

### BRIEF DESCRIPTION OF THE DRAWINGS

FIG. 1 is a schematic depiction of one embodiment of the present invention;

FIG. 2 is a flow chart for page fault handling in accordance with one embodiment of the present invention; and

FIG. 3 is a system depiction for one embodiment.

### DETAILED DESCRIPTION

In some embodiments, graphics processing applications may use complex data structures, such as databases, using a shared virtual memory model between one or more central processing units and a graphics processing unit on the same platform when they share page tables managed by the platform operating system. The use of shared virtual memory may reduce the overhead related to copying and repacking data from user space into drive memory on the graphics processing unit.

However, the operating system running on a host central processing unit may not be aware that the graphics processing unit is sharing virtual memory and so the host operating system may not provide for flushing translation look-aside buffers (TLB's). In some embodiments, a shared virtual memory manager on the host central processing unit handles the task of flushing the TLB's for the graphics processing unit.

A host operating system may manage page table entries for a plurality of processors in a multi-core system. Thus, when the operating system changes process page table entries, it flushes the translation look aside buffers for all the affected central processing units in the multi-core system. That operating system tracks, for each page table, which cores are using that page table at the moment, and flushes the translation look-aside buffers of those cores using the page table.

While the term graphics processing unit is used in the present application, it should be understood that the graphics processing unit may or may not be a separate integrated circuit. The present invention is applicable to situations where the graphics processing unit and the central processing unit are integrated into one integrated circuit.

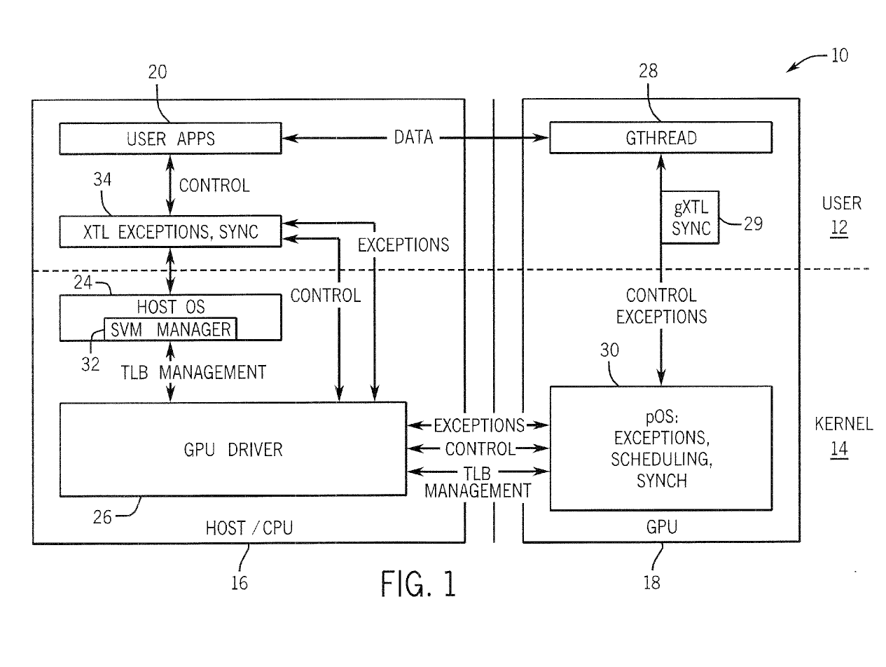

Referring to FIG. 1, in the system 10, a host/central processing unit 16 communicates with the graphics processing unit 18. The host central processing unit 16 includes user applications 20 which provide control information to an eXtended Thread Library (XTL) 34. The library 34 is a pthread extension to create and manage user threads on the graphics processing unit 18. The library 34 then communicates exceptions and control information to the graphics processing unit driver 26. The library 34 also communicates with the host operating system 24.

As shown in FIG. 1, the user level 12 includes the library 34 and the user applications 20, while the kernel level 14 includes a host operating system 24, and the graphics processing unit driver 26. The graphics processing unit driver 26 is a driver for the graphics processing unit even though that driver is resident in the central processing unit 16.

The graphics processing unit 18 includes, in user level 12, the gthread 28 which sends and receives control and exceptions messages to the operating system 30. A gthread is user code that runs on the graphics processing unit, sharing virtual memory with the parent thread running on the central processing unit. The operating system 30 may be a relatively small operating system, running on the graphics processing unit, that is responsible for graphics processing unit exceptions. It is a small relative to the host operating system 24, as one example.

User applications 20 include any user process that runs on the central processing unit 16. The user applications 20 spawn threads on the graphics processing unit 18.

The gthread or worker thread created on the graphics processing unit shares virtual memory with the parent thread. It behaves in the same way as a regular thread in that all standard inter-process synchronization mechanisms, such as Mutex and semaphore, can be used. Synchronization signals 29 may be passed between the library 34 and the gthread 28 via the GPU driver 26 and operating system 30.

The shared virtual memory (SVM) manager 32 on the host operating system 24 registers all SVM capable devices on the host, the graphics processing unit or other central processing units in multi-core environments. The manager 32 connects corresponding callbacks from operating system memory management (e.g. translation look-aside buffer (TLB) flushes) to drivers of SVM-capable devices.

In some embodiments, the parent thread and the graphics processing unit worker threads may share unpinned virtual memory. In some cases, the host operating system advises all of the central processing unit cores in a multi-core system when the host changes the process page table entries. But the graphics processing unit may also use the page table as well. With the conventional system, the graphics processing unit gets no notice of page table entry changes because the host operating system is not aware that the graphics processing unit is using the page table. Therefore, the host operating system cannot flush the graphics processing unit's translation look-aside buffer.

Instead, an operating system service, called the shared virtual memory manager 32, keeps track of all shared virtual memory devices that use the monitored page table. The shared virtual memory manager notifies each current page table user when the page table change happens, as indicated by arrows labeled TLB Management in FIG. 1.

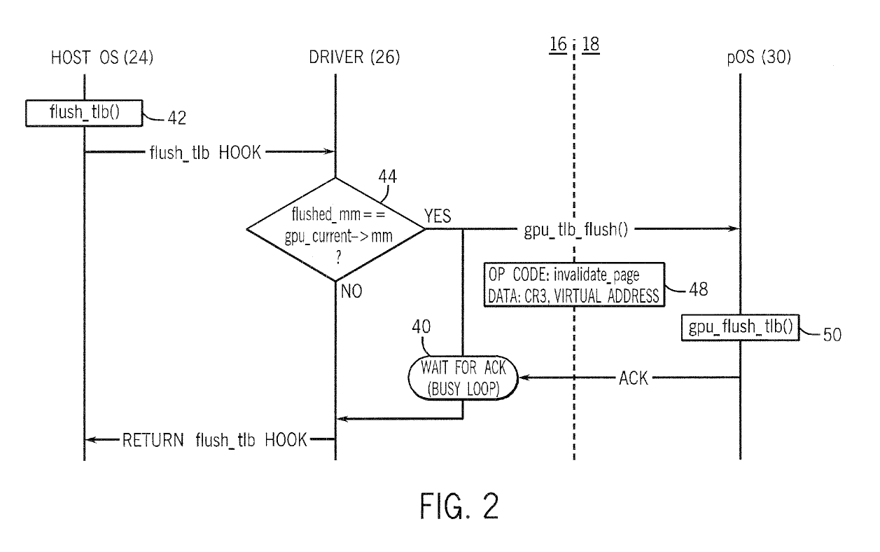

Referring to FIG. 2, the page fault handling algorithms may be implemented in hardware, software and/or firmware. In software embodiments, the algorithms may be implemented as computer executable instructions stored on a non-transitory computer readable medium, such as optical, semiconductor, or magnetic memory. In FIG. 2, the flows for the host operating system 24, driver 26 of the central processing unit 16, and the operating system 30 in the graphics processing unit 18 are shown as parallel vertical flow paths with interactions between them indicated by a generally horizontal arrows.

Referring to FIG. 2, the host operating system 24 calls a translation look aside buffer (TLB) flush routine at block 42. That routine flushes the TLBs of other central processing unit cores as needed. Then the host operating system activates callbacks to all drivers of shared virtual memory devices, one by one. For example, the flush_tlb hook is sent from the host operating system 24 to the driver 26 to activate callbacks for the graphics processing unit. At diamond 44, the driver checks to see if any active task has the same memory manager as the one that was flushed. If not, it simply returns the flush_tlb hook. If so, it sends a message gpu_tlb_flush( ) to the graphics processing unit operating system 30. That message 48 includes an op code to invalidate the page and data including the control register 3 (CR3) and virtual address. The control register 3 is X86 architecture specific and translates virtual addresses into physical addresses. However, corresponding operators can be used in other architectures.

The operating system 30 then does the graphics processing unit flush, as indicated at block 50, and provides an acknowledge (ACK) back to the driver 26. The driver 26 waits for the acknowledge at oval 40 and then returns to normal operations upon receipt of the acknowledge.

As a result, TLB coherency can be preserved for combined central processing unit and graphics processing unit shared virtual memory with common page tables managed by the host operating system through an extension of an existing operating system virtual memory mechanism. This solution does not require page pinning in some embodiments.

While the embodiment described above refers to graphics processing units, the same technique can be used for other processing units which are not recognized by the host central processing unit that typically manages the TLB flushing.

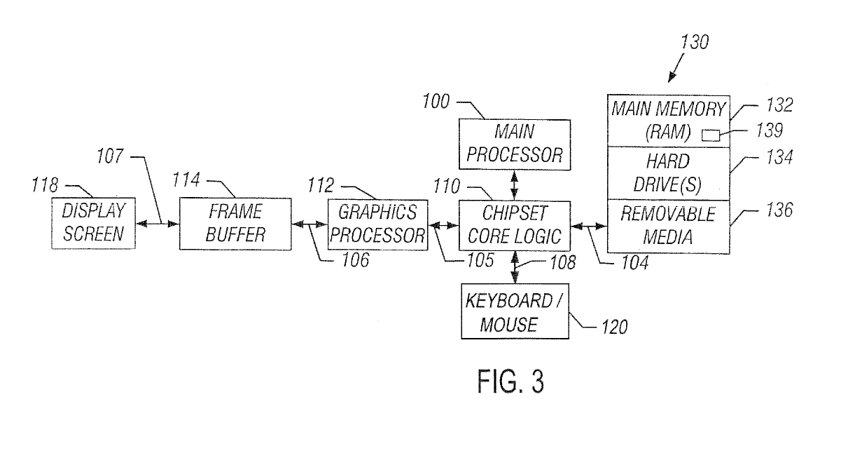

The computer system 130, shown in FIG. 3, may include a hard drive 134 and a removable medium 136, coupled by a bus 104 to a chipset core logic 110. A keyboard and mouse 120, or other conventional components, may be coupled to the chipset core logic via bus 108. The core logic may couple to the graphics processor 112, via a bus 105, and the central processor 100 in one embodiment. In a multi-core embodiment, a plurality of central processing units may be used. The operating system of one core may then be deemed the host operating system.

The graphics processor 112 may also be coupled by a bus 106 to a frame buffer 114. The frame buffer 114 may be coupled by a bus 107 to a display screen 118. In one embodiment, a graphics processor 112 may be a multi-threaded, multi-core parallel processor using single instruction multiple data (SIMD) architecture.

In the case of a software implementation, the pertinent code may be stored in any suitable semiconductor, magnetic, or optical memory, including the main memory 132 (as indicated at 139) or any available memory within the graphics processor. Thus, in one embodiment, the code to perform the sequences of FIG. 2 may be stored in a non-transitory machine or computer readable medium, such as the memory 132, and/or the graphics processor 112, and/or the central processor 100 and may be executed by the processor 100 and/or the graphics processor 112 in one embodiment.

FIG. 2 is a flow chart. In some embodiments, the sequences depicted in this flow chart may be implemented in hardware, software, or firmware. In a software embodiment, a non-transitory computer readable medium, such as a semiconductor memory, a magnetic memory, or an optical memory may be used to store instructions and may be executed by a processor to implement the sequences shown in FIG. 2.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
tracking changes to entries in a page table;
determining when a device other than a central processing unit is using the page table; and
notifying said device when a page table entry changes.

2. The method of claim 1 including sharing the page table between said first and second processing units.

3. The method of claim 2 including managing said based page table using the operating system of said first processing unit.

4. The method of claim 1 including using an operating system to track said changes to a page table entry and to notify said device when a page table entry changes.

5. The method of claim 1 wherein determining when a device is using the page table includes determining when a graphics processing unit is using the page table.

6. The method of claim 1 including using a shared virtual memory manager to notify said device.

7. A non-transitory computer readable medium storing instructions to enable a first processor to:
track changes to entries in a page table;
determine when a device other than a central processing unit is using the page table; and
notify said device when a page table entry changes.

8. The medium of claim 7 further storing instructions to share the page table between said first and second processor.

9. The medium of claim 8, said shared virtual memory to track page table changes and to report those changes to a graphics processing unit.

10. The medium of claim 7 including using a shared virtual memory manager to notify said device.

11. An apparatus comprising:
a processor to track changes to page table entries, determine when a device other than a central processing unit is using the page table, and notify said device when a page table entry change; and
a memory coupled to said processor.

12. The apparatus of claim 11 wherein said processor is a central processing unit.

13. The apparatus of claim 11 wherein said device is a graphics processing unit.

14. The apparatus of claim 11 wherein said device to use unpinned shared virtual memory.

15. The apparatus of claim 14 wherein said processor and said device share said unpinned virtual memory.

16. The apparatus of claim 11, said processor to share the page table between said processor and said device.

17. The apparatus of claim 12, said processor to manage said shared page table and operating system to track said changes and to notify said device when a page table entry changes.

18. The apparatus of claim 11 including a shared virtual memory manager to notify said device.
